(19) United States
(12) Patent Application Publication
(10) Pub. No.: US 2006/0114302 A1
(43) Pub. Date: Jun. 1, 2006

(54) Method of treating image receiving sheets and a hot melt ink jet printer employing this method

(75) Inventor: Lodewijk T. Holtman, Venlo (NL)

Correspondence Address: BIRCH STEWART KOLASCH & BIRCH, PO BOX 747, FALLS CHURCH, VA, 22040-0747, US

(73) Assignee: OCE-TECHNOLOGIES B.V., Venlo (NL)

(21) Appl. No.: 11/285,352

(22) Filed: Nov. 23, 2005

(30) Foreign Application Priority Data
Nov. 25, 2004 (EP) 04106087.2

(51) Int. Cl. B41J 2/175

(52) U.S. Cl. 347/88; 347/101

(57) ABSTRACT

A hot melt ink jet printing system and method is defined in which sheets are advanced to a print surface where hot, molten ink is applied to the sheets, and the sheets, prior to reaching the print surface, are heated to a first temperature that is higher than a second temperature which they will assume on the print surface, so as to prevent the sheets from cockling.

This non-provisional application claims priority under 35 U.S.C. § 119(a) on Patent Application No. 04106087.2 filed in Europe on Nov. 25, 2004, which is herein incorporated by reference.

### BACKGROUND OF THE INVENTION

The present invention relates to a method of treating image receiving sheets in a hot melt ink jet printer, in which the sheets are advanced to a print surface where hot, molten ink is applied onto the sheets. The present invention is also directed to a printer employing the present method.

US 6 196 672 B1 discloses a hot melt ink jet printer wherein, in order to accelerate the process of heating the sheets to a temperature that assures a suitable solidification of the ink, a preheater is provided which preferably has a higher surface temperature than the print surface.

In printers in which paper sheets or similar image receiving sheets are used as recording media, a tendency of the paper to cockle may sometimes constitute a serious problem. The cockling phenomenon is related to the fact that paper and similar materials tend to absorb humidity from ambient air and to expand and contract in accordance with their humidity content. Typically, the expansion and contraction is unisotropic and is particularly pronounced in a direction in which the fibers of the paper are predominantly oriented. When there exists a gradient in humidity within the paper, then the more humid portion of the paper will expand more than the drier portion, which inevitably leads to the production of cockles or wrinkles.

In a typical setup of an ink jet printer, especially in a large format printer, the paper is intermittently advanced over a flat sheet support plate, while a carriage moves back and forth across the paper, and ink jet printheads mounted on the carriage are energized to eject droplets of ink onto the paper so as to form a printed image. Since the carriage moves with relatively high velocity, the ink droplets ejected onto the paper undergo a certain aberration and are deposited on the paper in a somewhat dislocated position. The amount of dislocation is proportional to the flight distance of the ink droplets. Thus, when cockles are present in the paper, the flight distance is non-uniform and, accordingly, the dislocation of the spots of ink on the paper also becomes non-uniform, so that the quality of the printed image is deteriorated.

In a hot melt ink jet printer, the ink is solid at room temperature and must be heated above its melting point, typically in the order of magnitude of 100° C., before droplets of liquid ink can be jetted onto the paper. As a result, when the image is being printed, the paper will be heated by the high temperature of the ink, and part of the water that has been absorbed in the paper will evaporate. This creates a humidity gradient in the paper in the area of the print station, and the production of cockles is likely to occur.

### SUMMARY OF THE INVENTION

One of the objects of the present invention to provide a method and a hot melt ink jet printer which are efficient in suppressing the cockling phenomenon.

According to the present invention, the sheets, immediately before they reach the print surface, are heated-to a first temperature that is higher than a second temperature which they will assume on the print surface.

The present invention is primarily based on the following consideration. When a paper sheet is maintained at a temperature that is significantly higher than the temperature the sheet used to have previously, the humidity that has been absorbed in the paper will gradually be driven out, and the paper will shrink. However, the humidity content of the paper does not decrease linearly but will rather decay with a certain time constant, pursuant to a curve that resembles an exponential curve. Thus, initially, the humidity gradient is steep, and it flattens more and more as time passes. At a higher temperature, the time constant will be smaller and the humidity content will decay more rapidly. Since, according to the present invention, the sheet is heated to a relatively high temperature, the humidity content moves down the steep initial portion of the decay curve within a relatively short time, and when the paper reaches the print surface, the humidity content is already on the flat “tail” of the curve, which will be even flatter because the temperature on the print surface is lower. As a result, the time gradient of the humidity content will be small when the paper is advanced over the print surface, and, consequently, the spatial humidity gradient will also be small, so that the cockling tendency of the sheet is reduced significantly.

The effect that has been described above will be more pronounced when the sheet is heated to a higher temperature. On the other hand, the temperature should not become too high in order to prevent damage to the paper. Moreover, an excessive initial temperature of the paper would delay the solidification of the ink that is applied in the print process. Therefore, preferably, the first temperature to which the sheet is pre-heated should be about 10 to 25% higher than the second temperature on the print surface, if temperatures are measured in centigrade. For example, if the average temperature of the paper on the print surface is about 32° C., then the paper should be pre-heated to a temperature of about 38° C.

It is also preferable that the paper is exposed to the higher first temperature for a relatively long time, which means that the pre-heating zone along the paper transport path should be relatively long, of course without causing to much delay in the paper feed process and without making the overall dimensions of the printer excessively large. In a preferred embodiment, the paper is stored, e. g. in the form of an endless web on a reel, in a paper magazine that is located below the print surface, and the pre-heating zone is provided in an inclined portion of the paper feed path immediately upstream of a feed roller which deflects the paper into a horizontal direction and feeds it onto the print surface. This provides a sufficiently long pre-heating zone without substantially increasing the footprint of the printer and also permits the arrangement of the heating zone in close proximity to the print surface, so that the paper will not cool down again before it reaches the print surface. If the paper is supplied in web form, the fibers of the paper are predominantly oriented in transverse direction of the web, and consequently shrinkage will occur mainly in width direction of the web. Thus, the cockles produced by a humidity gradient will extend in longitudinal direction of the web. Then, the fact that the web is bent when it passes over the feed roller helps to smooth out any cockles that may have been produced in the pre-heating process.

In one of the features of the present invention, the printer contains a humidity sensor arranged to detect the degree of humidity of ambient air, and a control system adapted to control the pre-heating process in response to the detected degree of humidity. When the air is relatively dry, the cockling tendency is low, and the pre-heating temperature may be lowered or the heat treatment may be dispensed with completely in order to save energy. On the other hand, when the humidity of the ambient air increases, this is detected by the humidity sensor, and the heater is automatically activated so as to mitigate the cockling phenomenon and to assure a high print quality.

The pre-heating temperature may also be adapted to the type of paper that is being processed. For example, when the paper magazine has a plurality of reels storing webs with different widths or different paper qualities, the pre-heating temperature may automatically be switched to the value that is most appropriate for the type of paper that is being processed. Likewise, the active zone of the heater may automatically be adapted in width to the width of the web, so that a waste of energy is avoided.

The pre-heating treatment may also be applied when processing a non-paper recording medium, e.g., a plastic film. In this case, the sheets will be less sensitive to humidity but may have a larger thermal expansion coefficient, so that cockling may be caused by a gradient in temperature. Then, the pre-heating temperature will be selected only slightly above the temperature on the print surface, so that the temperature of the sheet, when it reaches the print surface, will match the temperature of the print surface itself. Also adjustments can be made in the temperature control system to correspond to the speed of conveyance of the web of material to be printed.

### BRIEF DESCRIPTION OF THE DRAWINGS

A preferred embodiment of the invention will now be described in conjunction with the drawings, in which:

FIG. 1 shows a schematic vertical cross-section of a paper transport system of a hot melt ink jet printer according to the present invention;

FIG. 2 is a schematic view of a paper sheet, illustrating the occurrence of cockles caused by a humidity gradient in the paper; and

FIG. 3 is a diagram illustrating how the humidity content of the paper changes in the course of time.

### DETAILED DESCRIPTION OF THE INVENTION

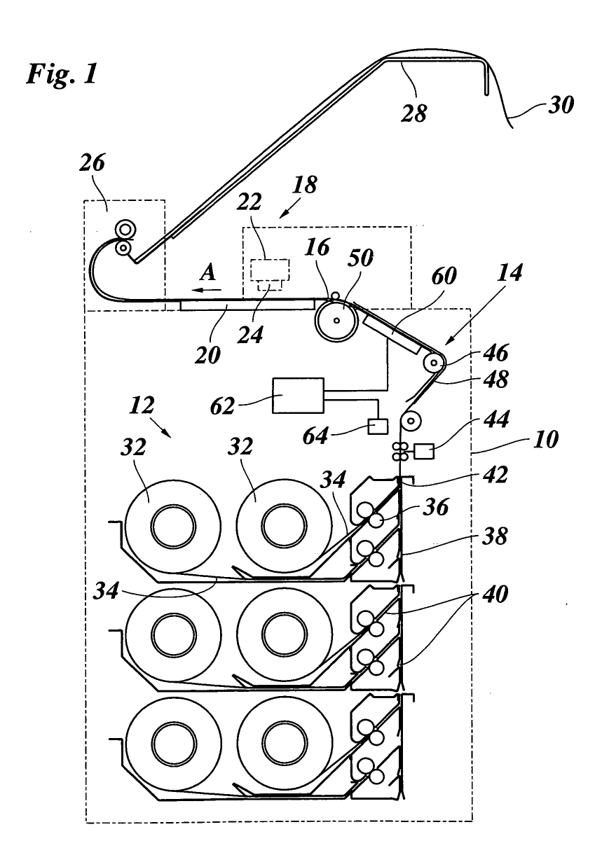

As is shown in FIG. 1, a hot melt ink jet printer comprises a frame 10 (which has only been shown in phantom lines) and which accommodates a paper magazine 12 and a paper feed system 14 adapted to feed a sheet 16 of paper to a print station 18 on the top side of the frame 10. In the print station 18, the sheet 16 is sucked against a flat top surface (print surface) of a perforated sheet support plate 20 by means of a vacuum system (not shown). A carriage 22 is arranged to travel back and forth across the sheet 16 in the direction normal to the plane of the drawing in FIG. 1 and carries at its bottom side a number of hot melt ink jet printheads 24 facing the sheet 16. Thus, by energizing the printheads 24, a swath of an image is printed in each pass of the carriage 22. Then, the sheet 16 is advanced by a step of appropriate length in a direction indicated by an arrow A, so that the next swath can be printed. A discharge mechanism 26 discharges the sheet onto a tray 28 which, in the example shown, accommodates already a printed sheet 30. The sheet support plate 20 is temperature-controlled in order to control the cooling rate and the solidification of the hot melt ink that has been deposited on the paper. For example, the temperature of the print surface of the sheet support plate 20 is maintained at about 32° C.

The paper magazine 12 comprises a set of six reels 32 each providing a supply of printing paper in the form of an endless web 34. The reels 32 are arranged in three levels, and the web 34 from each reel is drawn-off by means of a respectively associated pair of transport rollers 36. An arrangement of guide plates 38 defines a branched system of narrow feed paths 40 which merge into a common feed path 42 on the top side of the paper magazine. The pairs of transport rollers 36 are selectively driven to feed the web 34 from a selected one of the reels 32 to the common feed path 42. It will be understood that the reels 32 may contain paper of different qualities and possibly also non-paper recording media such as plastic films or the like. Further, the webs on the reels 32 may differ in width, so that printed sheets may be produced in different formats, ranging, for example, from A4 portrait to A0 andscape.

From the common feed path 42, the selected web is guided past a cutting mechanism 44 for cutting the web to the desired sheet length, and then the cut sheet 16 is guided over a system of deflection and tensioning rollers 46 and guide plates 48 to a feed roller 50 from which it is paid out onto the sheet support plate 20. On its way from the reel 32 to the feed roller 50, the web 34 and the sheet 16, respectively, will inevitably be exposed to ambient air and, as a result, will absorb humidity, especially when the relative humidity RH of the ambient air is high. In the example shown, the paper is particularly exposed to ambient air in the vicinity of the cutting mechanism 44.

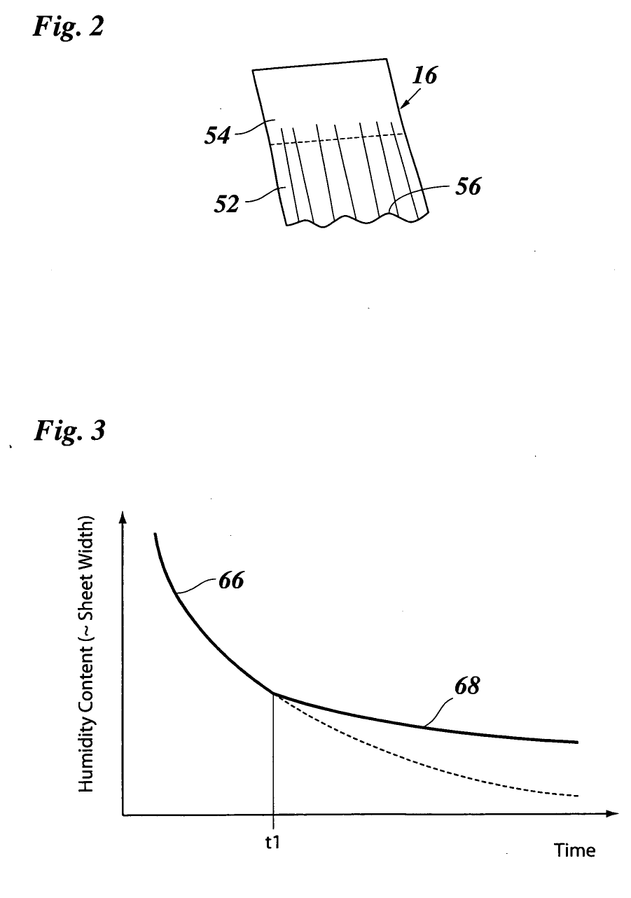

When the humidity content of the paper increases, it tends to expand, in particular in the direction in which the fibers in the paper are predominantly oriented. Typically, this is the direction transverse to the longitudinal direction of the web. When the sheet 16, after having expanded in this way, reaches the sheet support plate 20 and is heated by the hot melt ink deposited thereon, part of the water contained in the paper will be evaporated, and the paper shrinks again in width direction of the sheet. Thus, since a humidity gradient is present in the paper, the accompanying reduction in width of the sheet leads to the production of cockles. This has exaggeratedly been illustrated in FIG. 2, where a dashed line indicates an approximate border between a more humid portion 52 and a drier portion 54 of the sheet 16. The shrinkage in width of the drier portion 54 leads to the formation of cockles 56 in the portion 52.

In order to reduce the occurrence of such cockles 56 especially in the area of the print station 18, a heater 60 is provided at an inclined portion of the paper feed path just upstream of the feed roller 50, so that the humidity content of the sheet 16 is reduced before it enters the print station. The heater 60 may, for example be formed by a heated plate along which the sheet 16 is guided. Since the sheet may cockle when it passes along the heater, the heat transfer to the sheet is preferably achieved not only by direct contact but also by heat radiation. As an alternative, the heater may also be formed by a radiator of a hot air blower or, in general, any type of heat and any type of heat application which will achieve the desired effect. The top surface of the paper on the heater is preferably exposed to ambient air, so that the moisture evaporating from the paper will efficiently be removed by convection.

The heater 60 is controlled by an electronic control system 62 which is also connected to a humidity sensor 64. In the example shown, the sensor 64 is arranged in a position where it can detect the humidity of air near a portion of the paper feed path where the paper is particularly exposed to ambient air. Thus, when the air humidity is high, the heater 60 is heated to a higher temperature in order to drive the humidity out of the paper more efficiently. When the air humidity is lower, the temperature of the heater 60 may be reduced, so that energy consumption is also reduced. Below a certain threshold level of about 40% RH, for example, the heater 60 may be switched off completely, because, then, the amount of cockling is within tolerable limits, anyway.

The control system 62 may also be programmed to establish a different relationship between the detected air humidity and the temperature of the heater 60, depending on the quality (e.g., paper weight) of the print medium on the selected reel 32. For example, the threshold for switching between an ON and an OFF state of the heater may be shifted.

In addition, the heater 60 may be segmented in width direction, whereby the width of the active part of the heater will automatically be adapted to the width of the paper web, so as to avoid a waste of heat energy.

That when the humidity of ambient air is high, the heater 60 will heat the sheet 16 to a temperature of about 38° C., for example. This temperature is higher than the temperature of the print surface (32° C). The effect of this pre-heating strategy will now be explained in conjunction with FIG. 3.

When a sheet 16 is intermittently fed towards the feed roller 50, the humidity content of a certain area of the sheet which gradually travels along the heater will follow a “decay” curve 66 shown in FIG. 3. This curve is initially relatively steep but becomes flatter in the course of time. Would the sheet 16 be constantly kept at the temperature of 38° C., the humidity content would follow the flat “tail” of the curve 66 that has been shown in dashed lines in FIG. 3.

However, at a certain point of time t1, the pertinent area on the sheet passes over the feed roller 50 and reaches the print surface on the sheet support plate 20. The temperature will drop while the sheet moves over the feed roller 50. In order to prevent this temperature drop from becoming too large, the feed roller 50 may be made of a material or may be coated with a material having a low heat conductivity. As the sheet moves further over the print surface towards the printheads 24, its temperature will gradually approach 32° C. The hot melt ink applied by the printheads 24 will transfer a certain amount of heat onto the sheet, but this heat will rapidly be dissipated through the temperature-controlled sheet support plate 20. As a result, as long as the sheet passes over the sheet support plate 20, the temperature of the sheet will be kept close to 32° C. This temperature corresponds to a slower decay of the humidity content, as is indicated by the curve 68 in FIG. 3. It can be seen, that this curve 68 is relatively flat, so that the gradient in the humidity content is very small, and, correspondingly, the sheet will hardly shrink further in width as it travels over the sheet support plate. As a result, the production of cockles, especially in the region of the print station 18, is successfully suppressed.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A method of treating image receiving sheets in a hot melt ink jet printer, in which the sheets are advanced to a print surface where hot, molten ink is applied to the sheets, wherein prior to reaching the print surface, the sheets are heated to a first temperature that is higher than a second temperature which they will assume on the print surface.

2. The method according to claim 1, wherein the first temperature, when measured in centigrade, is about 10 to 25% higher than the second temperature.

3. The method according to claim 1, wherein the print surface is temperature-controlled to maintain the sheet at said second temperature.

4. The method of claim 1, wherein when the average temperature of the image receiving sheet is about 32° C., the image receiving sheet is preheated to a temperature of about 38° C.

5. The method of claim 4, wherein during the preheating step the image receiving sheet is conveyed in an inclined manner.

6. A hot melt ink jet printing system containing a print surface and a sheet transport system for conveying image receiving sheets to and over the print surface, wherein a heater and a temperature control system for controlling the heater is arranged at a paper feed path upstream of the print surface for controlling the temperature of the image receiving sheets prior to reaching the print surface.

7. The printing system according to claim 6, wherein a humidity sensor is arranged to detect the degree of humidity of ambient air, and the control system is adapted to control the heater in response to the detected degree of humidity.

8. The printing system according to claim 6, wherein the control system is adapted to switch off the heater when the detected degree of humidity is below a certain threshold level.

9. The printing system according to claim 6, wherein the control system is adapted to establish different relations between the detected degree of humidity and the activity the heater, depending on the type of printing sheets being fed to the print surface.

10. The printing system according to claim 6, wherein the paper transport system is adapted to supply the sheets from a magazine, that is operatively associated with the print surface, to a feed roller situated at an upstream end of the print surface, and the heater is arranged at an inclined portion of the paper feed path upstream of the feed roller.

11. The hot melt ink jet printer system of claim 10, wherein the inclined printer of the paper feed path is immediately upstream of the feed roller.

12. The hot melt ink jet printing system of claim 6, wherein the heater is segmented to adjust to variable sheet widths.
